(19) United States
(12) Patent Application Publication
(10) Pub. No.: US 2011/0214221 A1
(43) Pub. Date: Sep. 8, 2011

(54) Thermal Athletic Glove

(76) Inventor: Joseph P. Munda, Glen Head, NY (US)

(21) Appl. No.: 13/107,519

(22) Filed: May 13, 2011

Related U.S. Application Data
(63) Continuation-in-part of application No. 12/286,514, filed on Sep. 29, 2008.

(51) Int. Cl. A63B 71/14; B32B 15/04

(52) U.S. Cl. 2/161.1; 428/457

(57) ABSTRACT

A metalized composite material has an outer layer, a metalized layer and an insulation layer. The metalized layer has a surface coated with metallic material where the metallic surface faces away from the outer layer. Radiant heat from the skin of a wearer of a garment made with the metalized composite material is reflected back toward the skin surface of the wearer tending to keep the wearer warm in cold environments. The metalized composite material can be used to make garments and various types of articles of clothing and accessory applications for protection from cold and wet weather.

This application is a Continuation-in-Part of application Ser. No. 12/286,514 filed on Sep. 29, 2008.

### BACKGROUND OF THE INVENTION

1. Field of the Invention

The present invention relates to a glove, and more particularly, a thermal athletic glove.

2. Description of the Prior Art

Numerous innovations for multi-ply gloves have been provided in the prior art that will be described. Even though these innovations may be suitable for the specific individual purposes to which they address, however, they differ from the present invention.

A FIRST EXAMPLE, U.S. Pat. No. 3,096,523, Issued on Jul. 9, 1963, to Bruchas teaches a football glove comprising a wrist strap, a palm portion, individual finger and thumb stalls, the backs of the finger stalls extending from the tips thereof to a zone between the first and second joints of the wearer's fingers and each having an elastic portion in the zone adapted to grip and retain the fingers in the stalls, the remaining part of the back of the glove being open, the glove having patches of tactile gripping material secured at the balls of the thumb and finger stalls, the glove otherwise being of a less tactile gripping material than the patches.

A SECOND EXAMPLE, U.S. Pat. No. 4,662,006, Issued on May 5, 1987, to Ross teaches a multi-ply glove or mitt construction having a multi-ply shell and a multi-ply selectively removable liner is provided with interengaging contacting surfaces. The shell is formed by an outer water repellant layer and an inner heat insulating layer, between which is sandwiched a relatively waterproof breathable layer. A slide layer is formed on the inner surface of the inner heat insulating layer. The insulating layer of the shell is preferably formed of a lofting material such as down, DACRON or THINSULATE fiber, or the like natural or synthetic fibrous materials lending themselves to lofting. The slide layer faces the interior of the glove and is formed of a material providing a shiny surface by means of a non-brushed knit or woven synthetic such as nylon and/or similar sheet synthetic. The interior removable liner is formed of relatively porous moisture absorbent material such as a pile fabric, or woven, knitted, or felted fabric of natural or synthetic fiber, or encased lofting material having a preferably coarse outer surface layer, and relatively smooth inner surface layer. The interior of the shell and the exterior of the liner are provided preferably adjacent their cuffs with interengaging means, preferably in the form of VELCRO.

A THIRD EXAMPLE, U.S. Pat. No. 4,723,324, Issued on Feb. 9, 1988, to Lassiter teaches a thermal and/or protective glove construction which increases tactile sensitivity. In each of the thumb and fingertip portions of the glove there is provided a finger contact pad and a relatively stiff transmission system for transmitting detected vibrations from external stimuli to the wearer's fingertips. The finger contact pads may be Velcro™ fastener material and the transmission system may comprise a plurality of rigid plastic prongs embedded in the relatively thick insulating material used in thermal gloves. Additional response surface pads, which also may be of Velcro™ fastener material, may be applied to the external side of the transmission material.

A FOURTH EXAMPLE, U.S. Pat. No. 4,881,276, Issued on Nov. 21, 1989, to Swan teaches a cold weather sports glove including at least one of the fingers or thumb having an area of low coefficient of friction and at least one opposing finger or thumb having an area of high coefficient of friction. The glove is formed with a layer of compressible neoprene foam rubber which forms the outer surface of the glove having a high coefficient of friction. Nylon pads are coupled to the outer surface of the foam rubber layer at the distal ends of preselected fingers or thumb. The area of low friction, formed by the nylon pads, permits the user to perform activities requiring a relative slipping motion between the user's finger or thumb and the device being used. The area of high friction, formed by the foam rubber layer, permits the user to grasp and release objects with more sensitivity and precision due to its compressibility. In fishing, preferably the thumb and index finger of the glove have areas of low coefficient of friction. In hunting, preferably the index finger of the glove is covered with an area of low coefficient of friction on both its palm and backhand sides. In archery, preferably the index finger, the middle finger and the pinky have areas of low coefficients of friction on their palm side to permit the bowstring to slide thereon when released. In a snowmobile mitt, preferably the index finger has an area of low coefficient of friction, while the thumb and the mitt portions are covered with areas of high coefficients of friction.

A FIFTH EXAMPLE, U.S. Pat. No. 5,117,509, Issued on Jun. 2, 1992, to Bowers teaches an improved athletic glove having superior gripping properties generally comprising a palm piece and a back piece joined together to fit the human hand. The palm piece is made of a sheet of leather material prepared by a chrome tanning process or synthetic leather material having a substantially continuous layer of silicone sealant covering the palm side thereof. The layer of sealant is bonded to the palm side and does not penetrate through the palm side to the hand of a wearer.

A SIXTH EXAMPLE, U.S. Pat. No. 5,829,061, Issued on Nov. 3, 1998, to Visgil et al. teaches a molded work glove for providing protection to the hand and fingers of a wearer against cold and abrasion: A hand portion is made of a sheet foam material having a thickness between 1 mm and 5 mm. A hand cavity is disposed in the hand portion and is defined by the sheet foam material. Finger portions are mounted to the periphery of the hand portion and extend outwardly. The finger portions have a palm side and a back side and a tip located distal to the hand portion. The finger portions are made of a sheet foam material having a thickness between 1 mm and 5 mm. Finger cavities are disposed in the finger portions and are defined by the sheet foam material. The sheet foam material is an elastic, nonabsorbent, insulating material. The finger cavity at the tip is sized to loosely fit the finger of the wearer such that a gap is formed between the finger of the wearer and the sheet foam material. At least one aperture is disposed in the palm side at the tip of at least three finger portions. The aperture is sized to allow the fingers of the wearer to selectively pass through the apertures and be seated in the apertures in a snug fit.

A SEVENTH EXAMPLE, WIPO Document No. WO/1999/030584, Issued on Jun. 24, 1999, to Kang teaches an athletic glove having consistent gripping ability in various moisture conditions generally comprising a palm piece and a back piece joined together to fit the human hand. A palm piece is made of impregnated polyurethane artificial leather having a silicone printing on it. In this case, printed silicone elastomeric sealant preferably done by silk-printing on the impregnated polyurethane artificial leather in repeated patterns of lines of narrow width, tiny dots, small letters, various tiny shapes, the combination of the above, or etc. with a considerable bare leather fabric surface not having silicone printing, makes the gloves not only have more improved gripping ability than bare impregnated polyurethane leather, but also have consistent gripping ability in various moisture conditions without losing its original good, soft and supple feel, finger motion, tactile response of original impregnated polyurethane artificial leather, when the silicone elastomeric sealant is penetrated properly into and bonded firmly with the fibers of the polyurethane artificial leather as not to be embossed but to be a plain impregnated surface after curing. Even the flowing water on the surface of this plain silicone printing is expelled easily as to prevent thin water film effects because water contents on the silicone surface are squeezed and absorbed easily by the capillary absorption phenomenon of the bare artificial leather fibers adjacent to the silicone surface at the same level. In order to embody the present invention, on the impregnated polyurethane artificial leather, the silicone elastomeric sealant is silk-printed preferably with two type silicone elastomeric sealant which requires more than a day to cure at room temperature, but cures in a minute or two at 130-170.degree. C. and provides consistent and improved gripping ability which does not change in various moisture conditions.

AN EIGHTH EXAMPLE, U.S. Pat. No. 5,926,847, Issued on Jul. 27, 1999, to Eibert teaches exemplary golf gloves and methods for their use. In an exemplary embodiment, a flexible golf glove is provided having a glove S body having a palmar side and a dorsal side. A plurality of finger portions and a thumb portion each having a palmar side and a dorsal side are operably attached to the glove body. The glove further comprises at least one resilient pad comprising silicone foam operably attached to the palmar side of the glove body.

A NINTH EXAMPLE, U.S. Pat. No. 7,086,093, Issued on Aug. 8, 2006, to Carey et al. teaches a glove having a heat insulating barrier. The heat insulating barrier is removably inserted into a zippered pocket or a weblike pouch, the pocket or pouch being positioned proximate the back of a user's hand. The heat insulating barrier acts to selectively reduce heat conduction from the back side of the hand, thereby allowing the user's hand or hands to remain warm in cold environments. The ability to stack a varying number of heat insulating layers in the pouch or pocket further allows the user to selectively control the warmth of the hand as the ambient temperature fluctuates during use.

It is apparent now that numerous innovations for multi-ply gloves have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a thermal athletic glove that avoids the disadvantages of the prior art.

ANOTHER OBJECT of the present invention is to provide a thermal athletic glove that is simple and inexpensive to manufacture.

STILL ANOTHER OBJECT of the present invention is to provide a thermal athletic glove that is simple to use.

BRIEFLY STATED, STILL YET ANOTHER OBJECT of the present invention is to provide a thermal athletic glove which comprises a back side portion that has an inner layer to provide comfort to a hand and fingers of a person, an intermediate layer to lock heat in, and an outer layer to keep the heat in. A palm side portion has an inner layer to provide comfort to the hand and the fingers of the person, an intermediate layer to lock the heat in, and an outer layer to provide an optimal grip while allowing maximum flexibility for the fingers and the hand of the person.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view of an embodiment of the present invention;

FIG. 2 is an enlarged diagrammatic cross-sectional view taken on line 2-2 in FIG. 1;

FIG. 3 is a further enlarged diagrammatic cross-sectional view, taken in the area enclosed in the dotted circle indicated by arrow 3 in FIG. 2, showing the particular materials which are incorporated in the back side portion of the present invention in greater detail;

FIG. 4 is a further enlarged diagrammatic cross-sectional view, taken in the area enclosed in the dotted circle indicated by arrow 4 in FIG. 2, showing the partical materials which are incorporated in the palm side portion of a first embodiment of the present invention in greater detail; and

FIG. 5 is a further enlarged diagrammatic cross-sectional view, taken in the area enclosed in the dotted circle indicated by arrow S in FIG. 2, showing the particular materials which are incorporated in the palm side portion of a second embodiment of the present invention in greater detail.

FIG. 6 is an enlarged exploded cross sectional view of a metalized composite material;

FIG. 6A is a metalized layer of the metalized composite material;

FIG. 7 is an enlarged exploded cross sectional view of another embodiment of the metalized composite material.

### A MARSHALING OF REFERENCE NUMERALS UTILIZED IN THE DRAWING

10 thermal athletic glove
12 back side portion of thermal athletic glove 10
14 inner layer of back side portion 12
16 hand of person 20
18 finger of person 20
20 person
22 intermediate layer of back side portion 12
24 outer layer of back side portion 12
26 palm side portion of thermal athletic glove 10
28 inner layer of palm side portion 26
30 intermediate layer of palm side portion 26
32 outer layer of palm side portion 26
34 fleece material for inner layer 14
36 polyethylene material for intermediate layer 22
38 neoprene material for outer layer 24
40 fleece material for inner layer 28
42 polyethylene material for intermediate layer 30
44 leather material for outer layer 32
46 silicone impregnated tactile material for outer layer 32
48 elastic wrist band of thermal athletic glove 10
50 VELCRO closure of elastic wrist band 48
52 securing mechanism of thermal athletic glove 10
54 thread stitching for securing mechanism 52

### DETAILED DESCRIPTION OF THE PREFERRED EMBODIMENT

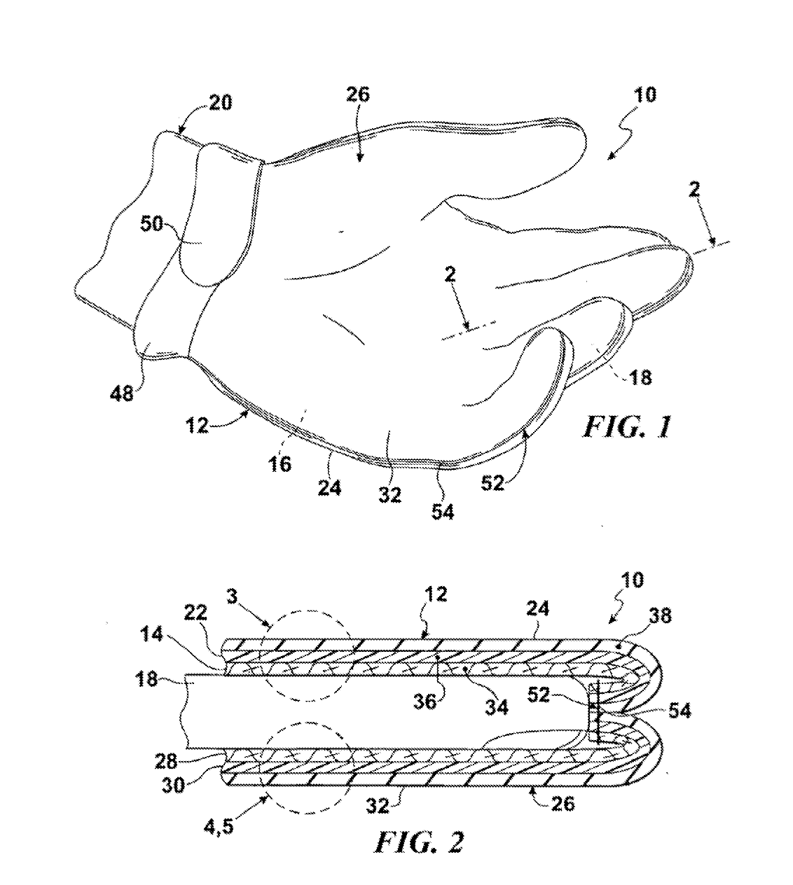

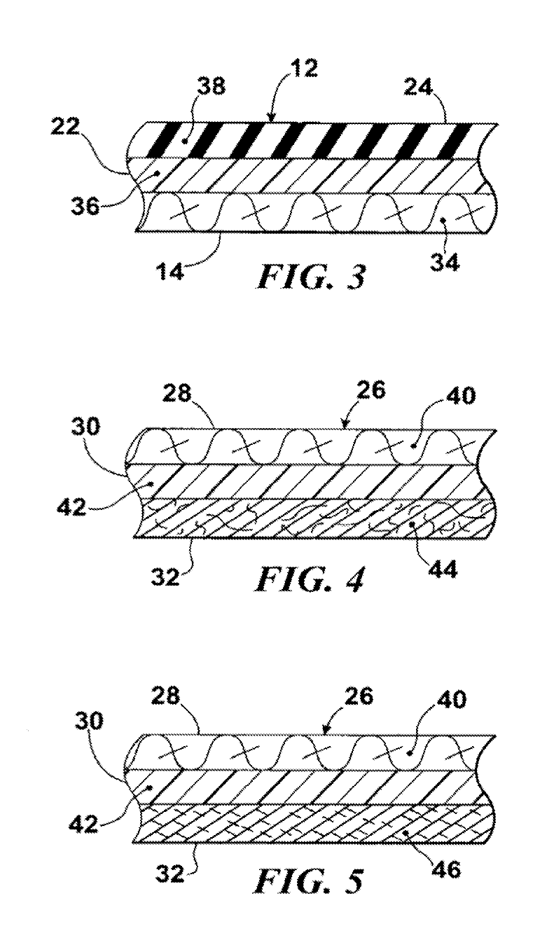

Referring now to the figures, in which like numerals indicate like parts, and particularly to FIGS. 1 through 5, which are a diagrammatic perspective view of an embodiment of the present invention; an enlarged diagrammatic cross-sectional view taken on line 2-2 in FIG. 1; a further enlarged diagrammatic cross-sectional view, taken in the area enclosed in the dotted circle indicated by arrow 3 in FIG. 2, showing the particular materials which are incorporated in the back side portion of the present invention in greater detail; a further enlarged diagrammatic cross-sectional view, taken in the area enclosed in the dotted circle indicated by arrow 4 in FIG. 2, showing the particular materials which are incorporated in the palm side portion of a first embodiment of the present invention in greater detail; and a further enclosed diagrammatic cross-sectional view, taken in the area enclosed in the dotted circle indicated by arrow 5 in FIG. 2, showing the particular materials which are incorporated in the palm side portion of a second embodiment of the present invention in greater detail, and as such, will be discussed with reference thereto.

The present invention is a thermal athletic glove 10 which comprises a back side portion 12 that has an inner layer 14 to provide comfort to a hand 16 and fingers 18 of a person 20, an intermediate layer 22 to lock heat in, and an outer layer 24 to keep the heat in. A palm side portion 26 has an inner layer 28 to provide comfort to the hand 16 and the fingers 18 of the person 20, an intermediate layer 30 to lock the heat in and an outer layer 32 to provide an optimal grip while allowing maximum flexibility for the fingers 18 and the hand 16 of the person 20. The inner layer 14 of the back side portion 12 is comprised out of a fleece material 34. The intermediate layer 22 of the back side portion 12 is comprised out of a polyethylene material 36. The outer layer 24 of the back side portion 22 is comprised out of a neoprene material 38.

The inner layer 28 of the palm side portion 26 is comprised out of a fleece material 40. The intermediate layer 30 of the palm side portion 26 is comprised out of a polyethylene material 42. As shown in FIG. 4, the outer layer 32 of the palm side portion 26 is comprised out of a leather material 44. As shown in FIG. 5, the outer layer 32 in the palm side portion 26 is comprised out of a silicone impregnated tactile material 46.

The thermal athletic glove 10, further comprises an elastic wrist band 48 having a hook and loop fastener such as a VELCRO closure 50. A snap on fastener, zipper, a drawstring closure, an extended wrist cuff with elastic closure, or a button with corresponding button hole all or any combination thereof can be used as a fastener for the glove. The thermal athletic glove further comprises a mechanism 52 for securing the back side portion 12 to said palm side portion 26. The securing mechanism 52 comprises thread stitching 54 through the perimeter of the back side portion 12 and the palm side portion 26.

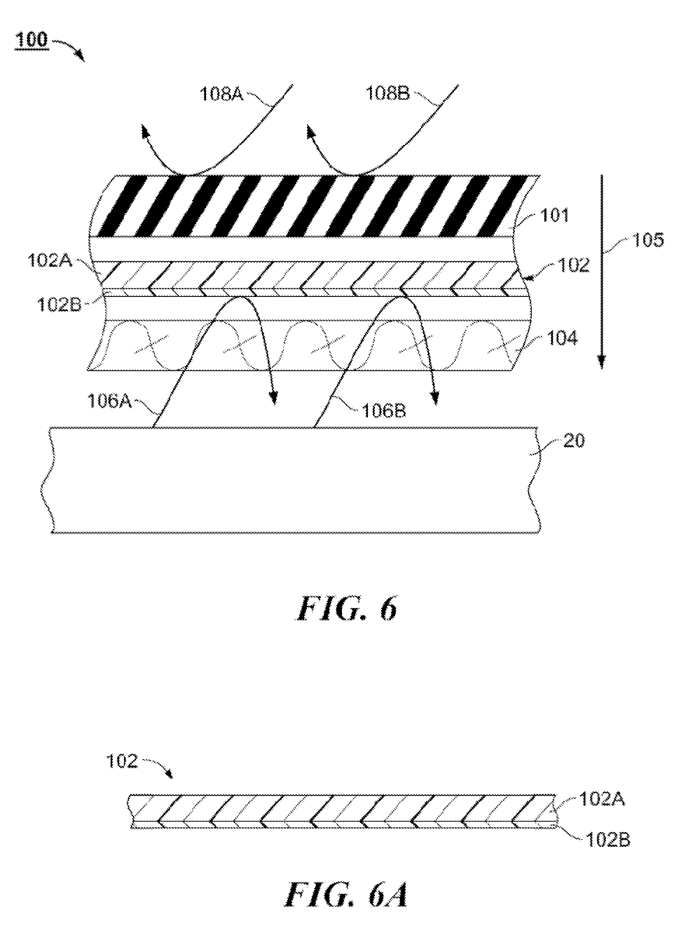

Referring now to FIG. 6, there is shown a cross sectional view of a metalized composite material 100 of the present invention which is used to make, construct or manufacture a thermal glove with the same structure as the thermal glove in FIG. 1. The thicknesses of each of the layers of composite material 100 are not necessarily drawn to scale with respect to each other. The invention may be used to make various types of clothing, footwear, and accessory applications designed to address the issues of a wearer's exposure to cold and/or wet weather and the ability to perform tasks under these weather conditions; the metalized composite material can thus be used to make cold weather performance apparel. The material 100 has an outer layer 101 and at least one metalized layer 102. Referring temporarily to FIG. 6A, the metalized layer 102 comprises a substrate 102A having oppositely facing surfaces at least one of which is coated with a metallic material to form a relatively thin metal coating 102B resulting in a metalized surface. An article of clothing made with the metalized composite material of the present invention and which is worn with the metalized surface of the metalized layer facing skin surfaces of the wearer of the article of clothing will retain much of the radiant heat generated by the body of the wearer (due to reflection by the metal coating of the radiant heat from the wearer's skin), will wick away excess moisture on the skin of the wearer, will deflect external cold air and is breathable due to a certain amount of air permeability of the outer layer 101. The metal coating 102B is preferably formed through a process called vapor deposition which is discussed infra. Other processes for applying a metal coating to the substrate (i.e., some type of fabric or material) can be used; that is, the metallic coating can be applied through thermal bonding, chemical bonding, laminating or any form of adhesive. Preferably, the metallic material used for the metal coating is aluminum which is applied to a surface of substrate 102A through various well known processes some of which have already been mentioned above. The metallic material, however, is not limited to aluminum. The metallic coating when formed has micropores through which moisture can pass as will be discussed infra. It will be readily obvious to one skilled in the art to which this invention belongs that other types of metallic material (other metal elements or alloys) can be used to coat the substrate 102A using well known coating processes.

As already stated above, one process which can be used to apply the metal coating 102B to the substrate 102A is Vapor Deposition. Particular vapor deposition processes that can be used are Physical Vapor Deposition (PVD) or Chemical Vapor Deposition (CVD). Vapor deposition refers to any process in which materials in a vapor state are condensed through condensation, chemical reaction, or conversion to form a solid material. These processes are used to form coatings to alter the mechanical, electrical, thermal, optical, corrosion resistance and wear properties of the substrates on which the coatings are applied. In PVD processes, the substrate is subjected to plasma bombardment. One example of a method for a PVD coating process comprises the following steps: the metal which is to form the coating is converted to a gaseous state, i.e., a metal vapor or plasma; the metal vapor is then combined with an active gas such as nitrogen, oxygen or methane to promote condensation of the vapor onto the surface of the substrate. The primary methods used for creating the metal vapor and plasma in PVD are ion plating, ion implantation, sputtering and laser surface alloying. In contrast to conventional metallization procedures for textiles fibers and fabrics, PVD technologies allow the production of a defined structure of relatively thin films on most fabric surfaces. Textiles in which PVD is used for their metallization will obtain relatively superior characteristics in the following properties: anti-static, electrical conductivity, shielding against electromagnetic radiation, protection against heat rays, chemical resistance, bacterial contamination and thermal stability. In CVD processes, thermal energy heats gases of the metal in a coating chamber and drives a deposition reaction.

The metalized layer formed using vapor deposition as described above has the same or similar physical characteristics as other metalized layers known as “space blankets”, or “mylar blankets”. A mylar or space blanket can thus be used as the metalized layer 102 for the metalized composite material 100 of the present invention. For the mylar blanket or space blanket or any metalized layer made for the composite material 100, the substrate 102A of the metalized layer can be mylar, or a thin sheet of plastic such as polyethylene terephthalate (PET). A material of a relatively thin plastic sheet (i.e., PET) that is coated with a metallic heat reflecting agent becomes metalized polyethylene terephthalate or MPET. MPET is usually gold or silver in color and reflects up to 97% of the radiant heat it receives on its surface. Space blankets are made by vacuum depositing a very precise amount of pure aluminum vapor onto a relatively very thin, durable substrate. Other materials that can be used for the substrate 102A are polyester, spandex, fleece, lycra, cotton, nylon, wool, acrylic, rayon fabric or any combination of such materials in a blended fashion. The substrate 102A will have the ability to disperse excess moisture and has a degree of air permeability allowing excess heat to escape while blocking cold air. Further, the substrate 102A has the ability to absorb moisture (by a wicking process) passing through micropores of the metal coating 102B. The coating 102B of aluminum (or other suitable metal) is preferably in the range of 0.2 microns to 2.0 microns in thickness.

Several types of particular space blankets can be used in the metalized composite layer. For example, AFM Inc. SILVER LINING® FABRIC or AFM Inc Headsheets® are two specific examples of available space blankets. This fabric's ultra-thin, Infra Red reflective insulation layer is sandwiched between two protective layers of soft polyolefin film laminated to an ultra-light non-woven polypropylene. Silver Lining products are used as inner linings in various types of apparel such as parka overcoats, vest linings for sleeping bags, footwear and stand-alone ultra-light blankets and bedding. Silver Lining™ fabrics are relatively easy to cut and sew; they are available as Waterproof TF™ and Breathable Aire-TF™. They employ an IR (Infra Red and/or heat) reflective and insulation layer and they retain their reflective and insulation properties even when wet. The different mylar or space blankets described above can be used as the metalized layer 102 for the metalized composite material of the present invention to make the various mentioned apparels, viz., gloves, parka overcoats, sleeping bags, footwear, blankets and bedding products.

Referring back to FIG. 6 and thus continuing with the description of composite material 100, the outer layer 101 can be made with, for example, Kevlar®, neoprene, polyester, spandex, fleece, lycra, cotton, nylon, wool, acrylic, leather, or rayon fabric or any combination of such material in a blended fashion. The outer layer 101 will have sufficient thickness to disperse excess moisture and it has a certain amount of air permeability allowing any excess heat (located between layers 102 and 101) to escape while blocking cold air (cold air flow shown by arrows 108A, 108B). Excess moisture located between layers 102 and 101 is wicked away by outer layer 101. That is, the excess moisture may be moisture wicked away by inner layer 104 from skin 20 of a wearer of the thermal glove (or other garment made with the composite material of FIG. 6) and the wicked moisture passes through micropores of the metallic coating 102B and is absorbed by substrate 102A and then wicked away by outer layer 101. Outer layer 101 is a sweat wicking fabric constructed of water-repellent synthetic fibers such as polyester, which are specially woven to create “sweat corridors” that promote a capillary action (same action plants use to draw water to their extremities). Once the moisture is wicked away to the surface of outer layer 101 (i.e., outer surface of the garment) air movement and various heat sources in the environment enable the sweat to evaporate into the air. Outer layer 101 not only wicks the excess moisture, but is also a breathable material that allows excess heat to exit the garment. Thus, the particular construction of the fiber of outer layer 101 allows the moisture in the fabric to evaporate and allows excess heat to escape. The outer layer 101 may be waterproof or water resistant. Inner layer 104 is made from the same or similar materials (e.g., polyester, spandex, fleece, lycra, cotton, nylon, wool, acrylic, rayon fabric or any combination thereof) as outer layer 101 and has the water proof, water resistant and air permeability properties as outer layer 101. The metalized layer 102 is an intermediate layer sandwiched between outer layer 101 and inner layer 104. The metalized composite material 100 is shown relative to the skin surface 20 of the wearer of the thermal glove or an apparel or garment. The metal surface of the intermediate metalized layer faces inward meaning such metallic surface faces in the direction shown by arrow 105 (away from outer layer 101) toward the skin 20 of the wearer of the glove, garment or apparel made of the metalized composite material 100.

It will be readily understood that the metalized composite material 100 is formed by adhering, or otherwise attaching the various layers (outer layer, intermediate metalized layer, inner layer) to each other using well known methods or techniques. For example, all of the layers may be bonded to one another via thermal bonding, chemical bonding, weaving, stitching, chemical adhesive, thermal adhesive or any other type of textile bonding process to form a composite material. However, for ease of explanation, each of the layers of metalized composite material are shown separately in exploded cross sectional view in FIG. 6.

The thermal glove made with the composite material 100 of the present invention is designed and constructed in the same fashion as the glove in FIG. 1. That is, the glove comprises a palm side portion stitched, for example, to a back side portion as shown in FIG. 2. The two portions can be adhered or attached to each other using attachment methods other than stitching. In constructing the thermal glove of the present invention, because the metal coated surface is facing away from the outer layer, the composite material is oriented so that the metalized coating 102B of metalized layer 102 is facing inward, i.e., facing the skin surface of the wearer of the glove away from the outer layer 101. In this manner, radiant heat emanating from the skin surface of the wearer of the glove is reflected back to the skin surface 20 by the metal coating 102B. The flow of radiant heat and its reflection back to skin surface 20 is shown by arrows 106A and 106B. Further, any excess moisture on the skin surface 20 of a wearer of the thermal glove is absorbed by inner layer 104 through wicking and the moisture passes through the micropores of the metallic coating 102B, absorbed by substrate 102A and is eventually wicked away by outer layer 101 and then evaporates into the environment. The inner and outer layers 104, 101 are preferably made of breathable material; that is material having some air permeability. The outer layer preferably has the ability to disperse excess moisture and it has some air permeability to allow excess heat to escape while keeping cold air from penetrating the metalized composite material. The inner layer preferably will wick away excess moisture and has a degree of air permeability to allow excess heat to escape while blocking cold air from penetrating the metalized composite material. The metalized layer 102 is preferably waterproof or at least water resistant. Any and all of the three layers can be made to be water proof or water resistant through well known processes.

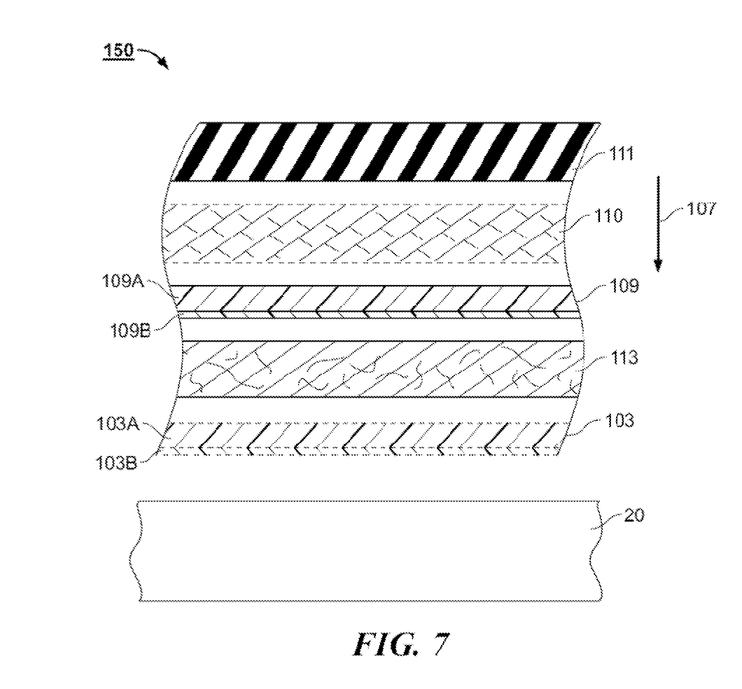

Referring now to FIG. 7, there is shown another embodiment of the metalized composite material of the present invention. Metalized composite material 150 comprises various combinations of outer layer 111, optional insulating layer 110, metalized layer 109, inner layer 113, and optional metalized layer 103. The optional metalized layer 103 comprises substrate 103A and metal coating 103B; metalized layer 109 comprises substrate 109A and metal coating 109B. The layers appearing in dashed lines represent optional structures for metalized composite material 150. For example, one embodiment of metalized composite material 150 can comprise outer layer 111, metalized layer 109 and inner layer 113. Another embodiment of metalized composite material 150 comprises outer layer 111, inner layer 110, metalized layer 109 and inner layer 113. Yet another embodiment of metalized composite material 150 comprises outer layer 111, inner layer 113 and metalized layer 103. Thus, various other embodiments may comprise outer layer 111, one or both of the inner layers 110, 113, and one of the metalized layers 109 or 103. Preferably the metal used is aluminum. Metalized layers 103 and 109 are constructed in the same manner and have the same components as metalized layer 102 of FIG. 6. Radiant heat (or infra-red energy) emanating from a heat radiating source such as skin layer 20 is reflected back to the skin by metal coating 1038 of metalized layer 103 or metal coating 109B of metalized layer 109. In particular, the metal coating 103B of metalized layer 103 (or the metal or the metal coating of metalized layer 109) is positioned so as to face skin layer 20 of the wearer of the thermal glove or garment or apparel; that is metal coating 103B faces away from outer layer 111 in the direction shown by arrow 107. Similarly, metalized layer 109 reflects heat back toward the skin 20 of the wearer of a glove or garment made with the composite material of the present invention. Outer layer 111, optional insulation layer 110 and inner layer 113 all are made of the same or similar materials and have the same properties as outer layer 101 and inner layer 104 of FIG. 6. It should be noted that when optional insulation layer 110 and optional metalized layer 103 are not used, the resulting composite material has the same structure as the composite material shown in FIG. 6.

The metalized composite materials 100 and 150 of FIGS. 6 and 7 respectively can be used to make garments for many types of article of clothing. For example, such wearable items as compression shirts, sweat shirts, pants, jackets, headgear such as helmets having an internal layer of the metalized composite material, hats and beanies, gloves, waders, jumpsuits, wet suits, socks, gloves, hats, scarves, footwear such as shoes, boots, work apparel or any other form of apparel can be made using the metalized composite materials of FIGS. 6 and 7. Garments worn by athletes, construction workers, and garments worn by workers whose occupation exposes them to the elements can be made of the metalized composite material of FIGS. 6 and 7. For example, a wetsuit worn by a diver or the clothing worn by a utility worker charged with repairing power lines in very cold weather can be made of the metalized composite material of FIGS. 6 and 7. The garments are constructed by cutting out garment sections made from the metalized composite material. The garments sections can then be sewn, stitched, adhered or otherwise attached to each other to create the desired garment. As with the thermal glove, the metal coating (i.e., the metalized surface) of the metalized layer(s) faces inward (away from the outer surface) in the direction shown by arrows 105, and 107 (see FIGS. 6 and 7) toward the skin surfaces of the wearer of the garment so that radiant heat emanating from the skin of the wearer of the garment is reflected back to the skin surface of the wearer; this tends to use a wearer's own body heat to keep him or her warm. The outer layer of metalized composite material of the present invention keeps the cold from penetrating the garment and the inner layer wicks away moisture which is then evaporated into the environment. The inner and outer layers are breathable in that they have a certain amount of air permeability to allow the flow of air outward promoting a dry but warm environment for the wearer of the garment.

The present invention has been described in terms of various embodiments as described herein. It will be readily understood that the embodiments disclosed herein do not at all limit the scope of the present invention. One of ordinary skill in the art to which this invention belongs can, after having read the disclosure may implement the present invention using other implementations that are different from those disclosed herein but which are well within the scope of the claimed invention.

It will be understood that each of the elements described above, or two or more together, may also find a useful application in other types of constructions differing from the types described above.

While the invention has been illustrated and described as embodiments of a thermal athletic glove, a thermal garment, and a metalized composite material accordingly it is not limited to the details shown, since it will be understood that various omissions, modifications, substitutions and changes in the forms and details of the apparel illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A thermal athletic glove comprising:
a back side portion;
a palm side portion;
the back side portion is attached to the palm side portion and both portions are made from a metalized composite material having at least one outer layer and at least one metalized layer with a metalized surface positioned to face away from the outer layer.

2. The thermal athletic glove of claim 1 wherein the metalized composite material comprises an outer layer, an intermediate layer and an inner layer, the intermediate layer being the layer with the metalized surface and is positioned between the outer layer and inner layer.

3. The thermal athletic glove of claim 1 wherein the metalized composite material comprises an outer layer attached to the at least one metalized layer.

4. The thermal athletic glove of claim 1 wherein the metalized composite layer comprises an outer layer, a first insulation layer, an intermediate layer, and a second insulation layer, the intermediate layer being the layer with the metalized surface and is positioned between the first and second insulation layers and the first insulation layer is positioned between the outer layer and the metalized layer.

5. The thermal athletic glove of claim 1 where the metalized layer comprises a substrate having a relatively thin coating of metallic material attached to one of its surfaces.

6. The thermal athletic glove of claim 1 where the metalized layer comprises a substrate having a first surface and a second surface and wherein one of the surfaces has a relatively thin coating of metal material attached thereof.

7. The thermal athletic glove of claim 6 where the substrate is a waterproof material and the metal coating is aluminum.

8. The thermal athletic glove of claim 6 where the substrate is polyethylene terephthalate material and the metal coating is aluminum.

9. The thermal athletic glove of claim 6 where the substrate is polyester material and the metal coating is aluminum.

10. The thermal athletic glove of claim 6 where the substrate is spandex material and the metal coating is aluminum.

11. The thermal athletic glove of claim 6 where the substrate is lycra material and the metal coating is aluminum.

12. The thermal athletic glove of claim 6 where the substrate is cotton material and the metal coating is aluminum.

13. The thermal athletic glove of claim 6 where the substrate is nylon material and the metal coating is aluminum.

14. The thermal athletic glove of claim 6 where the substrate is wool material and the metal coating is aluminum.

15. The thermal athletic glove of claim 6 where the substrate is acrylic material and the metal coating is aluminum.

16. The thermal athletic glove of claim 6 where the substrate is rayon material and the metal coating is aluminum.

17. The thermal athletic glove of claim 6 where the substrate is fleece material and the metal coating is aluminum.

18. The thermal athletic glove of claim 6 where the substrate is a combination of two or more materials and the metal coating is aluminum.

19. The thermal athletic glove of claim 1 where the composite material comprises a metallic layer sandwiched between layers of soft polyolefin film laminated to an ultra-light non-woven polypropylene material.

20. A thermal garment comprising:
one or more garment sections attached to each other each of which is made of composite material having at least one outer layer and at least one metalized layer with a metalized surface positioned such that the metalized surface faces away from the outer layer.

21. The thermal garment of claim 20 wherein the metalized composite material further comprises an inner layer with the metalized layer positioned between the outer layer and the inner layer.

22. The thermal garment of claim 20 wherein the outer layer is attached to the at least one metalized layer.

23. The thermal garment of claim 20 wherein the metalized composite layer comprises an outer layer, a first insulation layer, an intermediate layer, and a second insulation layer, the intermediate layer being the metalized layer with the metalized surface and is positioned between the first and second insulation layers and the first insulation layer is positioned between the outer layer and the metalized layer.

24. The thermal garment of claim 20 where the metalized layer comprises a substrate having a relatively thin coating of metallic material attached to one of its surfaces forming the metalized surface.

25. The thermal garment of claim 20 where the metalized layer comprises a substrate having a first surface and a second surface and wherein one of the surfaces has a coating of metal material attached thereon forming the metalized surface.

26. The thermal garment of claim 25 where the substrate is a waterproof material and the metal coating is aluminum.

27. The thermal garment of claim 25 where the substrate is polyethylene terephthalate material and the metal coating is aluminum.

28. The thermal garment of claim 25 where the substrate is polyester material and the metal coating is aluminum.

29. The thermal garment of claim 25 where the substrate is spandex material and the metal coating is aluminum.

30. The thermal garment of claim 25 where the substrate is lycra material and the metal coating is aluminum.

31. The thermal garment of claim 25 where the substrate is cotton material and the metal coating is aluminum.

32. The thermal garment of claim 25 where the substrate is nylon material and the metal coating is aluminum.

33. The thermal garment of claim 25 where the substrate is wool material and the metal coating is aluminum.

34. The thermal garment of claim 25 where the substrate is acrylic material and the metal coating is aluminum.

35. The thermal garment of claim 25 where the substrate is rayon material and the metal coating is aluminum.

36. The thermal garment glove of claim 25 where the substrate is fleece material and the metal coating is aluminum.

37. The thermal garment of claim 25 where the substrate is a combination of two or more materials and the metal coating is aluminum.

38. The thermal garment of claim 20 where the metalized layer comprises at least a metallic layer sandwiched between layers of soft polyolefin film laminated to an ultra-light non-woven polypropylene material.

39. A metalized composite material for making a garment, the composite material comprising:
an outer layer;
a metalized layer, the metalized layer having a substrate and a coating of metallic material applied to a surface of the substrate.

40. The composite material of claim 39 further comprising an insulation layer positioned such that the metalized layer is between the insulation layer and the outer layer.

41. The composite material of claim 39 wherein the metalized layer is between a first insulation layer and a second insulation layer where the first insulation layer is positioned between the outer layer and the metalized layer.

42. The composite material of claim 39 where the substrate is made from a non-metallic material.
